(19) United States
(12) Patent Application Publication
(10) Pub. No.: US 2025/0299401 A1
(43) Pub. Date: Sep. 25, 2025

(54) IMAGE PROCESSING APPARATUS AND NON-TRANSITORY COMPUTER-READABLE RECORDING MEDIUM THEREFOR

(71) Applicant: BROTHER KOGYO KABUSHIKI KAISHA, Nagoya (JP)

(72) Inventors: Kohei WATANABE, Nagoya (JP); Takumi KUROKAWA, Nagoya (JP)

(21) Appl. No.: 19/083,671

(22) Filed: Mar. 19, 2025

(30) Foreign Application Priority Data
Mar. 21, 2024 (JP) 2024-044633

(51) Int. Cl. G06T 11/60; G06T 7/13; G06T 11/00; G06T 11/20

(52) U.S. Cl. CPC G06T 11/60; G06T 7/13; G06T 11/001; G06T 11/203; G06T 2207/10024; G06T 2207/20081; G06T 2207/20084; G06T 2207/20212; G06T 2207/30201

(57) ABSTRACT

An image processing apparatus comprises a controller. The controller is configured to perform obtaining a target image representing an object, obtaining a contour image representing a contour of the object and a detail image representing more fine features of the object, generating a composite image by composing multiple images including the contour image and the detail image, and obtaining a new image by inputting the composite image to a machine learning model.

### REFERENCE TO RELATED APPLICATIONS

This application claims priority from Japanese Patent Application No. 2024-044633 filed on Mar. 21, 2024. The entire content of the priority application is incorporated herein by reference.

### BACKGROUND ART

The present disclosure relates to a technique of generating a new image based on an existing image.

Various machine learning models, such as diffusion models, generative adversarial networks (GANs) and auto encoders, can be used to generate new images. In other words, a machine learning model can generate various images based on images that are input to the machine learning model. For example, a machine learning model can generate images that have the same content as the input image, but in a specific style that is different from the style of the input image. Here, parameters of a trained machine learning model can be adjusted to suit generating images of the specific style. As a technique for adjusting parameters, a technique called LoRA (Low-Rank Adaptation of Large Language Models) can be used.

### SUMMARY

When the machine learning model is used, unintended results can be output. For example, when the machine learning model is used, unintended images can be generated.

According to aspects of the present disclosure, a non-transitory computer-readable recording medium contains computer-executable instructions that are executable by a controller of an image processing apparatus. The computer-executable instructions is configured to, when executed by the controller, cause the image processing apparatus to a first obtaining process of obtaining a target image representing an object, a second obtaining process of obtaining a contour image and a detail image, the contour image representing a contour of the object, the detail image representing more fine features of the object than features represented by the contour image, a composing process of generating a composite image by composing multiple images including the contour image and the detail image, and a third obtaining process of obtaining a new image by inputting the composite image to a machine learning model.

According to aspects of the present disclosure, a non-transitory computer-readable recording medium contains computer-executable instructions that are executable by a controller of an image processing apparatus. The computer-executable instructions is configured to, when executed by the controller, cause the image processing apparatus to generate an image by composing a first image and a second image, and obtain a new image by inputting the generated image to a machine learning model.

According to aspects of the present disclosure, an image processing apparatus comprises a controller configured to perform obtaining a target image representing an object, obtaining a contour image and a detail image, the contour image representing a contour of the object, the detail image representing more fine features of the object than features represented by the contour image, generating a composite image by composing multiple images including the contour image and the detail image, and obtaining a new image by inputting the composite image to a machine learning model.

According to aspects of the present disclosure, an image processing apparatus comprising a controller configured to perform generating an image by composing a first image and a second image, and obtaining a new image by inputting the generated image to a machine learning model.

### BRIEF DESCRIPTION OF DRAWINGS

FIG. 1 is a block diagram illustrating a configuration of an image processing apparatus according to a present embodiment.

FIG. 2 is a block diagram illustrating an example of a generative model.

FIG. 3 shows examples of images that are generated using a first adjustment parameter.

FIG. 4 is a flowchart illustrating an example of image processing.

FIG. 5 shows examples of images processed by the image processing.

FIG. 6 is a flowchart illustrating an example of preprocessing.

FIG. 7 shows examples of images that are processed by the preprocessing.

FIG. 8 shows examples of images that are obtained by the image processing using a sample image.

FIG. 9 is a flowchart illustrating another example of preprocessing.

FIG. 10 shows examples of images to be processed by the preprocessing.

FIG. 11 shows examples of images to be processed by the preprocessing.

FIG. 12 is a flowchart illustrating another embodiment of preprocessing.

FIG. 13 shows examples of images to be processed by the preprocessing.

FIG. 14 shows examples of images to be processed by image processing.

FIG. 15 is a flowchart illustrating still another embodiment of preprocessing.

FIG. 16 shows examples of images to be processed by the preprocessing.

FIG. 17 shows examples of images to be processed by the image processing.

### DESCRIPTION

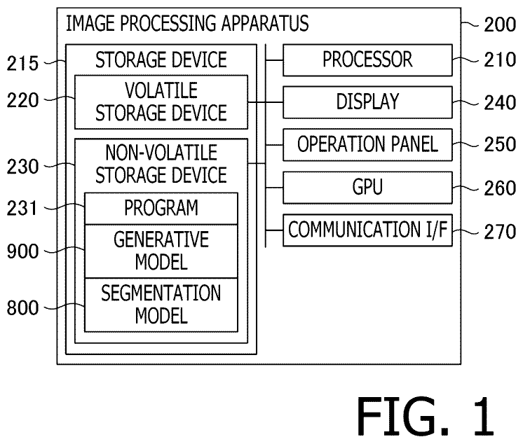

FIG. 1 illustrates a configuration of an image processing apparatus 200 according to a first embodiment of the present disclosure. The image processing apparatus 200 is, for example, a personal computer. The image processing apparatus 200 is configured to obtain a new image based on an existing image.

The image processing apparatus 200 has a processor 210, a storage device 215, a display 240, an operation panel 250, a graphics processing unit (GPU) 260, and a communication interface 270. These components are connected with each other via a bus. The storage device 215 includes a volatile storage device 220 and a non-volatile storage device 230.

The processor 210 is configured to perform data processing. The processor 210 is, for example, a central processing unit (CPU) or a system on a chip (SoC). The processor 210 is an example of a controller. The volatile storage device 220 is, for example, a dynamic random access memory (DRAM), and the non-volatile storage device 230 is, for example, a flash memory.

The non-volatile storage device 230 stores data for each of a program 231, a segmentation model 800, a generative model 900. Each of the segmentation model 800 and the generative model 900 is a program module forming trained machine learning models. Data stored in the non-volatile storage device 230 will be described later.

The display 240 is configured to display images and is, for example, an LCD (liquid crystal display) or an OLED (organic liquid crystal display). The operation panel 250 is a device configured to receive user operations, and is provided with buttons, levers, and a touch panel overlaid on the display 240. The display 240 and the operation panel 250 may configured as a so-called touchscreen panel. The user can input various requests and instructions into the image processing apparatus 200 by operating the operation panel 250. The display 240 may be configured to display elements for operation (e.g., buttons, sliders, but not limited to these), and the displayed elements may be operated through operation of the operation panel 250.

The GPU 260 is a computing device configured to perform various numerical operations, including image processing and machine learning. The GPU 260 performs various operations according to the instructions of the processor 210. A driver program (not shown) for controlling the GPU 260 may be provided by the manufacturer of the GPU 260.

The communication interface (I/F) 270 is for communicating with other devices. The communication interface 270 includes at least one of a USB I/F, a wired-LAN I/F, a wireless interface complaint to IEEE 802.11 standard (e.g., CamerLink, CoaXpress, or the like).

FIG. 2 is a block diagram illustrating an example of a generative model 900. The generative model 900 may be any model that uses input image data to generate output image data based on the input image. In the present embodiment, the generative model 900 is a machine-learning model called Stable Diffusion, for which the parameters have been adjusted using a technique called LoRA (Low-Rank Adaptation). The generative model 900 includes a diffusion model 960, which is the Stable Diffusion model, and adjustment parameters 990a and 990b.

Stable Diffusion is a model that composes high-resolution images using a Latent Diffusion Model (generative model). The technology for high-resolution image composition using a Latent Diffusion Model (generative model) is disclosed, for example, in the following paper:

Robin Rombach, Andreas Blattmann, Dominik Lorenz, Patrick Esser, Bjoern Ommer, “High-Resolution Image Synthesis with Latent Diffusion Models”, arXiv: 2112.10752, Apr. 13, 2022, http://arxiv.org/abs/2112.10752

Data for the pre-trained Stable Diffusion model is publicly available on the internet via Stability AI. In the present embodiment, the data of the pre-trained model that has been made public is used as the data for the diffusion model 960. The diffusion model 960 includes a text encoder 910, an image encoder 920, a latent variable model 930, and an image decoder 940.

The text encoder 910 is configured to convert text Ptx (also called as a prompt) into vector tv (such vector tv is also called as a text embedding).

The image encoder 920 is configured to convert an input image IMi to a latent variable Ivi. The latent variable model 930 is configured to perform a process that adds noise to the latent variable lvi, and a process that outputs the processed latent variable lvo by performing an inverse diffusion process that removes noise from a latent variable that includes noise. The latent variable model 930 includes a neural network called U-Net for performing the inverse diffusion process (figure omitted).

The image decoder 940 is configured to generate an output image IMo using the latent variable lvo. The latent variable model 930 uses, as a condition, the vector tv obtained from the text encoder 910 in the inverse diffusion process. The latent variable model 930 is configured to generate a latent variable lvo that corresponds to an image conditioned by the text Ptx by executing such an inverse diffusion process. The text encoder 910 is pre-trained in such a manner that the vector tv obtained from the text Ptx and the image represented by the text Ptx are associated. As the text encoder 910, a pre-trained encoder trained using a technique known as CLIP is used. CLIP is a technology developed by OpenAI.

The diffusion model 960 is configured to generate a new output image IMo represented by text Ptx by executing the reverse diffusion process using a randomly generated noise with use of vector tv from the text encoder 910. Such a technology is also called “txt2img.” Further, the diffusion model 960 is configured to generate a modified output image IMo that is modified in accordance with the text Ptx with use of the input image IMi and the text Ptx. Such a technology is called “img2img.”

The adjustment parameters 990a and 990b are configured to allow fine-tuning of the parameters (e.g., weighting, bias, but not limited to these) for the latent variable model 930. For example, the parameters used in the inverse diffusion process for the latent variable model 930 are fine-tuned using the adjustment parameters 990a and 990b. The parameters that are fine-tuned may include parameters of some of multiple layers contained in the U-Net.

In the present embodiment, the parameters for the latent variable model 930 are fine-tuned in such a manner that the generative model 900 generates output images IMo, in which the style of the input image IMi is converted to a particular style (e.g., line drawing, anime art, but not limited to these). That is, the fine-tuned generative model 900 can generate an output image IMo that expresses the same content as the input image IMi (e.g., a person) with a style different from the style of the input image IMi. Such a generative model 900 is also called a style transfer model.

There are various methods that can be used to adjust the parameters. In the present embodiment, a technology called LoRA is used. The LoRA is a technology that adjusts some of the parameters of a pre-trained model. For further details, see Rombach et al., arXiv: 2112.10752 mentioned above.

By using the LoRA, a set of parameter differences can be trained without changing the parameters of the pre-trained model. By combining the pre-trained model and the set of differences trained by the LoRA, a fine-tuned model is formed. The pre-trained model can be used commonly to prepare multiple sets of differences for multiple tasks. By replacing a difference set with another difference set, the tasks in the generative model 900 can be switched easily.

The adjustment parameters 990a and 990b represent the trained difference sets, respectively. In the present embodiment, the first adjustment parameter 990a is a difference set for generating the output image IMo of a line drawing. The line drawing is an image that includes lines representing objects (including outlines and boundary lines) and has no shading or color. The first adjustment parameter 990a is a trained difference set trained according to the LoRA. The trained difference set allows the generative model 900 to generate line drawing images based on multiple line drawing images IMta. When the first adjustment parameter 990a is used, the generative model 900 can generate, for example, a line drawing output image IMo1a representing the same person as is represented in the input image IMi1, which is a photograph of a person.

The second adjustment parameter 990b is a difference set for generating the output image IMo of the anime art. The anime art includes lines representing objects (including outlines and boundaries) and simplified color gradients. For example, a single region, such as a region of a person's skin or a region of clothing, is colored with a small number of colors (e.g., one, two, or three colors). The term “anime art” is also known as “flat-color painting.” The second adjustment parameter 990b is a difference set that is trained so that the generative model 900 generates anime art images using multiple anime art images IMtb according to the LoRA technology. When the second adjustment parameter 990b is used, the generative model 900 can generate, for example, an output image IMo1b of an anime art that represents the same person as a person represented by an input image IMi1.

It should be noted that, when the adjustment parameters 990a and 990b are used, the text Ptx may contain various texts that represent an image to be generated. For example, the text Ptx may contain text that indicates a style (e.g., line drawing, anime art, but not limited to these) for the image to be generated. Further, for training of the adjustment parameters 990a and 990b, a text Ptx containing particular text corresponding to the adjustment parameters may be used. When generating the output image IMo using the adjustment parameters, the text Ptx may contain particular texts that were used during the training of the adjustment parameters. It should be noted that inputting the text Ptx may be omitted.

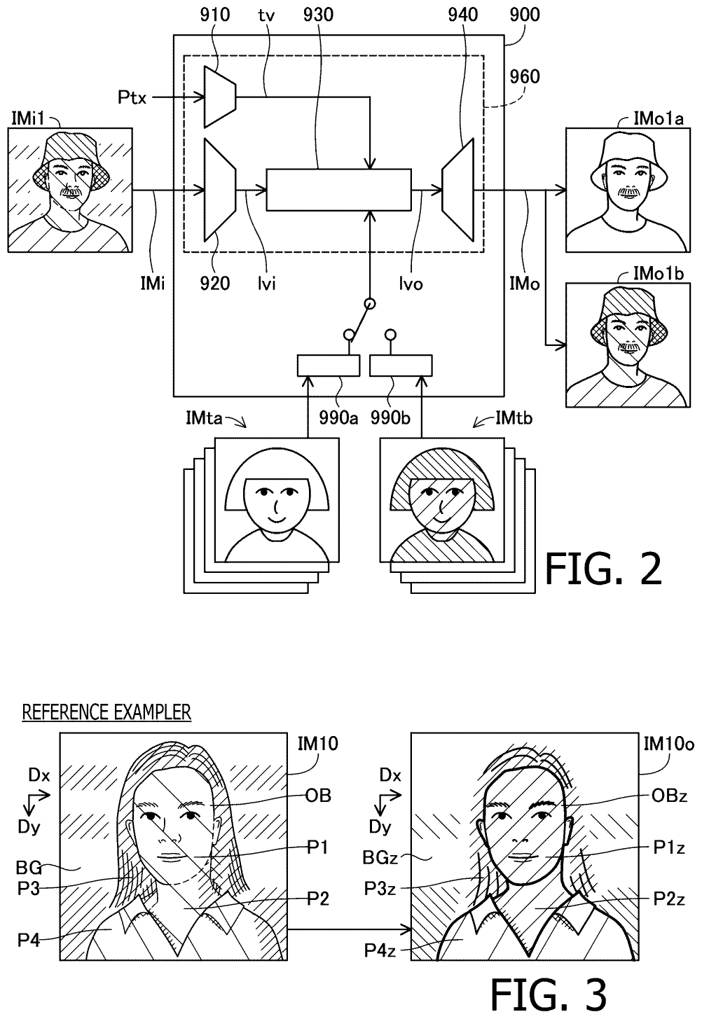

FIG. 3 shows examples of images that are generated with the use of the first adjustment parameter 990a. An image IM10 illustrates an example of an input image that is input to the generative model 900, and an image IM10o illustrates an example of an output image that is generated by the generative model 900. In the present embodiment, data of each of the images IM10 and IM10o is bit map data representing color values of three color components of R (red), G (green) and B (blue). Each of the images IM10 and IM10o is a rectangular image with two sides parallel to a first direction Dx and two sides parallel to a second direction Dy perpendicular to the first direction Dx. Each of the images IM10 and IM10o is represented by color values of individual pixels arranged in a matrix along the first direction Dx and the second direction Dy (the color values indicate the respective gradation values (e.g., e.g., values between zero and 255, inclusively) of red (R), green (G), and blue (B)). The number of pixels in the first direction Dx and in the second direction Dy that can be accepted by the generative model 900 are determined in advance and are the same for both the input image IM10 and the output image IM10o. The data format described above for the image data that is acceptable by the generative model 900 will be referred to as a process data format.

In the example shown in FIG. 3, the input image IM10 represents a color photograph showing an object OB and a background BG. The object OB is a person. A region representing an object OB includes a facial skin region P1 representing facial skin, a body skin region P2 representing body skin (excluding the facial skin), a hair region P3, and a clothing region P4. Each of the face, body, hair, and clothes is also a kind of an object. In this way, the object can contain any of multiple parts (i.e., multiple objects).

The processor 210 generates the output image IM10o of a line drawing by executing the operations of the generative model 900 using the input image IM10. It should be noted that the processor 210 may have the GPU 260 execute some or all of the operations of the generative model 900.

The generative model 900 could output unintended results. For example, there may be a case where a boundary between the hair region P3 and the background BG is blurred in the input image IM10. In such a case, the generative model 900 may not be able to generate an image that includes the boundary between the background BG and the hair region P3. For another example, the background BG and the object OB in the input image IM10 can be represented in various colors. In such a case, the generative model 900 may generate images representing the shading and color for each region.

The output image IM10o in FIG. 3 shows an example of an unintended result. The output image IM10o represents the same object OBz as the input image IM10. The output image IM10o represents regions P1z, P2z, P3z, P4z, and BGz, which correspond, respectively, to regions P1, P2, P3, P4, and BG represented by the input image IM10. In the output image IM10o, part of the boundary between the hair region P3z and the background BGz is missing. In the output image IM10o, the facial skin region P1z, body skin region P2z, hair region P3z, clothing region P4z, and background BGz represent color gradations in grayscale.

In the present embodiment, in order to reduce the possibility of unintended images being obtained from the generative model 900, the processor 210 performs preprocessing of the image to be input to the generative model 900.

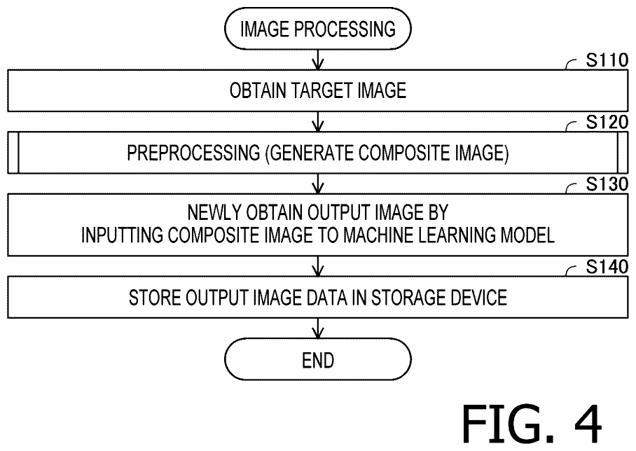

FIG. 4 is a flowchart illustrating the image processing. The processor 210 of the image processing apparatus 200 (FIG. 1) performs the image processing in accordance with the program 231 in response to an image processing start instruction that is input to the image processing apparatus 200. Any method may be used to input the start instruction. In the present embodiment, the user inputs the start instruction by operating the operation panel 250. The start instruction may contain designation information that designates data of the input image to be used in the image processing. The designation information may designate image data stored in any of various storage devices. The storage device may be selected from among the storage device 215 (e.g., non-volatile storage device 230), a not-shown storage device (e.g., USB flash drive) connected to the communication interface 270, and the storage device of a server that is configured to communicate with the image processing apparatus 200. In addition, the user may input the start instruction and the input image data into the image processing apparatus 200 via a not-shown terminal device (e.g., a smartphone) that is configured to communicate with the image processing apparatus 200.

In the image processing shown in FIG. 4, the processor 210 obtains data of a target image in response to the start instruction (S110). Then, the processor 210 stores the obtained data of the target image (hereinafter, referred to as target image data) in the storage device 215 (specifically, in the non-volatile storage device 230 according to the present embodiment). If the data format of the input image data differs from the process data format acceptable by the generative model 900, the processor 210 obtains the target image data by converting the data format of the input image data to the process data format. For example, if the data format of the input image data is different from the bitmap format (for example, if it is in a data format described in a page description language), the processor 210 obtains the image data in the process data format by rasterizing the input image data. If the data format of the input image data is the bitmap format (e.g., the JPEG format), the processor 210 obtains the target image data by converting the resolution of the input image data (i.e., the number of pixels in the first direction Dx and the number of pixels in the second direction Dy) to the resolution of the process data format. If the resolution of the input image data is the same as the resolution of the process data format, the processor 210 may adopt the input image data as the target image data as is.

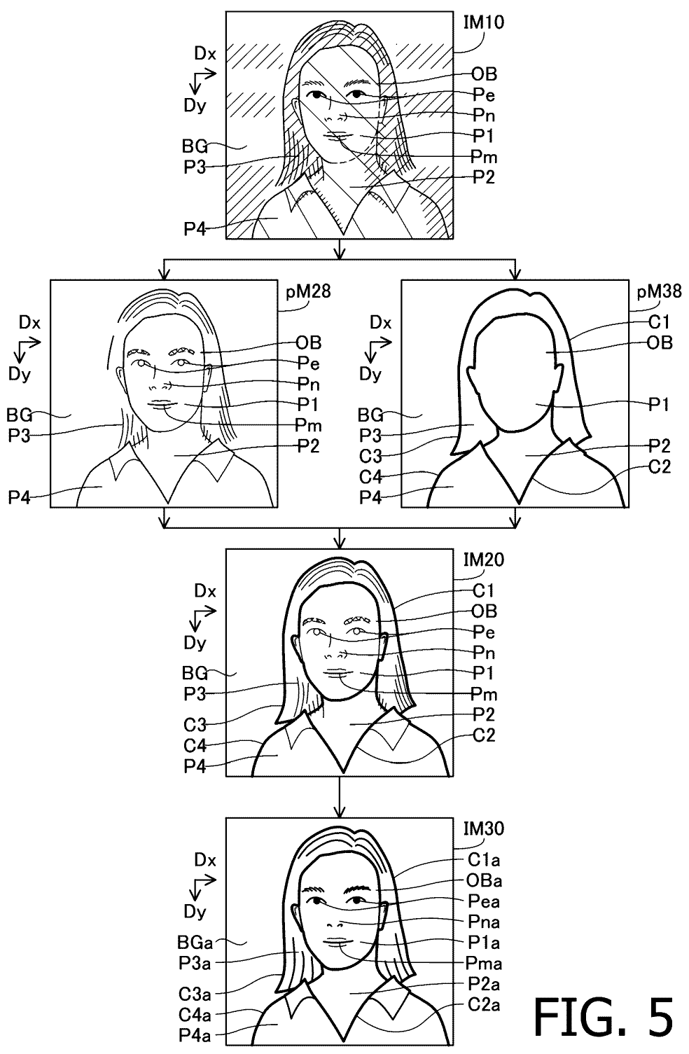

FIG. 5 shows examples of images that are processed by the image processing. The image IM10 in the figure represents an example of the target image. Hereinafter, it is assumed that the target image is the same as the input image IM10 in FIG. 3 (the image IM10 is referred to as the target image IM10).

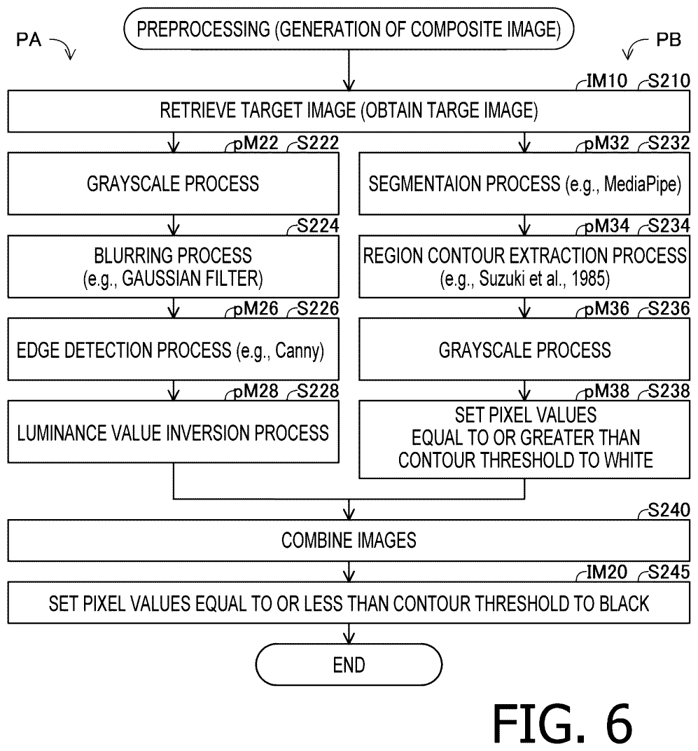

In S120 (FIG. 4), the processor 210 performs preprocessing. FIG. 6 is a flowchart showing an example of preprocessing. In FIG. 6, symbols beginning with “S” indicate steps. Symbols beginning with IM or “pM” indicate images that will be described later. The symbol for an image in a box corresponding to each step indicates an image that is obtained or generated in that step. For example, the box corresponding to S210 is labeled with the symbol IM10. This indicates that the image IM10 is obtained in S210. The same applies to the flowcharts for preprocessing in other embodiments described later.

In the present embodiment, the processor 210 is configured to perform the detail image obtaining process PA and the contour image obtaining process PB. The detail image obtaining process PA proceeds from S210 to S222-S228 and then to S240, while the contour image obtaining process PB proceeds from S210 to S232-S238 and then to S240. S210 is common to the detail image obtaining process PA and the contour image obtaining process PB (S210 may be executed only once for both of these processes PA and PB). The processor 210 performs these processes PA and PB through concurrent processing or parallel processing. It should be noted that concurrent processing refers to advancing multiple processes in an interleaved manner, while parallel processing refers to executing multiple processes simultaneously. Alternatively, the processor 210 may perform these processes PA and PB sequentially, one after another.

Initially, the detail image obtaining process will be described. In S210, the processor 210 retrieves data of a target image from the non-volatile storage device 230.

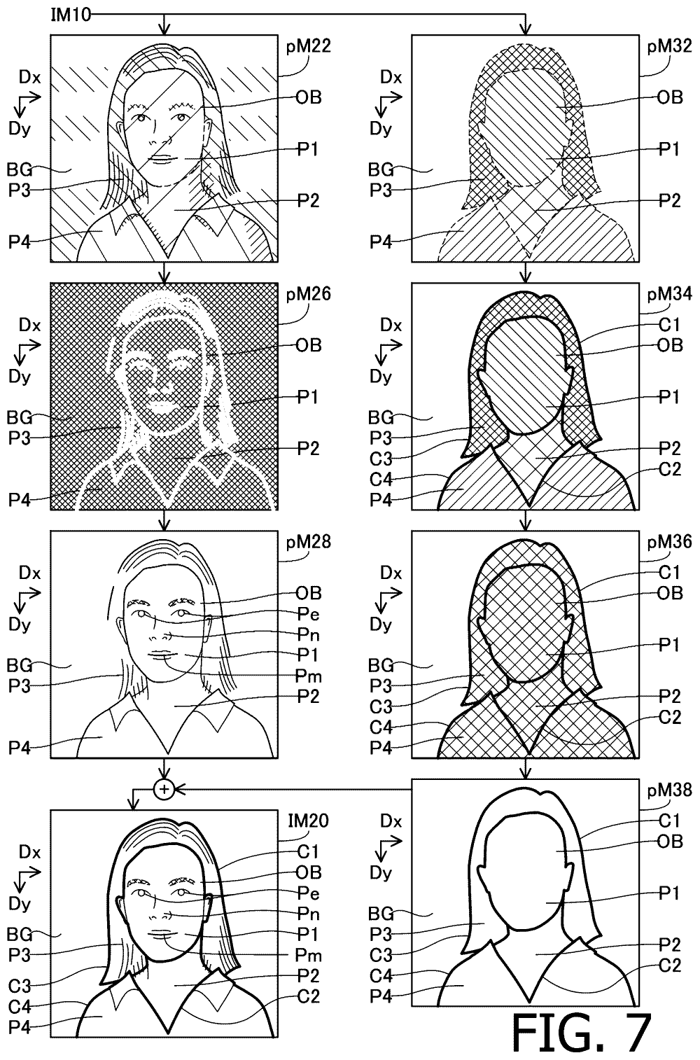

In S222, the processor 210 generates grayscale image data by performing a grayscale process on the target image IM10. By performing the grayscale process, the RGB color values are converted to luminance values using a particular formula (for example, a color conversion formula from the RGB color space to the YCbCr color space). FIG. 7 shows an example of an image that is to be processed by the preprocessing. An image pM22 on the left of the first row shows an example of a grayscale image generated in S222. The grayscale image pM22 represents an object OB in the same way as the target image IM10 does (FIG. 5).

In S224 (FIG. 6), the processor 210 generates grayscale image data with reduced noise by performing a blurring process on the grayscale image generated in S222. The blurring process may be any of a variety of processes that smooth out color values. In the present embodiment, the blurring process is a smoothing process using a Gaussian filter. As an alternative, any of a variety of smoothing filters, such as the average value filter and the median value filter, may be used. Although not shown in the drawings, by performing the blurring process, fine edges (e.g. noise) that are not features of the object OB in the grayscale image PM22 (FIG. 7) become less noticeable.

In S226 (FIG. 6), the processor 210 performs an edge detection process on the grayscale image processed in S224 to generate edge image data that expresses fine features of the object OB. In the present embodiment, the processor 210 performs a so-called Canny edge detection. An image pM26 on the left-hand side of the second row, from the top, in FIG. 7 shows an example of an edge image generated in S226. In the edge image pM26, edge pixels that represent edges are represented by large pixel values (e.g., the maximum value of 255), and non-edge pixels that do not represent edges are represented by small pixel values (e.g., the minimum value of zero). In this way, in the present embodiment, an edge image pM26 is generated that appears like a negative image of a photograph. Edge pixels in the edge image pM26 can represent the fine features of the object OB (details will be described later). It should be noted that the edge detection process may be any of a variety of processes for detecting edge pixels in an image. For example, the processor 210 may use a filter that calculates edge strength, such as a Laplacian filter or Sobel filter, to calculate the edge strength of each pixel, and may detect pixels with edge strength greater than a threshold value as edge pixels. Alternatively, a machine learning model trained to detect edges may be used (for example, a model called “informative drawings” may be used).

In S228 (FIG. 6), the processor 210 generates edge image data representing an image similar to a positive image of a photograph by inverting the pixel values (in this case, luminance values) of the edge image generated in S226. The pixel value Va before inversion is converted to the pixel value Vb after inversion according to a particular formula. The formula may be: Vb=maximum value (in this case, 255)−Va. An image pM28 on the left of the third row in FIG. 7 shows an example of an edge image generated in S228. In the edge image pM28, edge pixels representing edges are indicated by small pixel values (e.g., zero, the minimum value), and non-edge pixels that do not represent edges are indicated by large pixel values (e.g., 255, the maximum value). In the example in FIG. 7, the edge image pM28 represents the fine parts of the object OB, such as eyebrows, eyes Pe, a nose Pn, a mouth Pm, multiple hairs, and a collar of clothes.

In a case where boundaries between multiple regions in the target image IM10 (FIG. 5) are blurred, the boundaries may not be detected by the edge detection process (S226). For example, on the edge image pM28, part of the outline of the hair region P3 (for example, a part of the outline of the hair region P3 on the left-hand side of the facial skin region P1) is missing. The edge image pM28 is an example of a detail image that expresses fine features of the object represented by the target image (hereafter, the edge image pM28 is also referred to as the detail image pM28). With the completion of S228, the detail image obtaining process PA (FIG. 6) is terminated.

Next, the contour image obtaining process PB will be explained. As described above, S210 is common to processes PA and PB. When S210 is executed for the detail image obtaining process PA, S210 for the contour image obtaining process PB may be omitted.

In S232, the processor 210 performs a segmentation process on the target image IM10. The segmentation process is a process of dividing an image into multiple regions, respectively, representing multiple parts that form one or more objects represented by the image. In the present embodiment, the processor 210 performs the segmentation process by using a segmentation model 800 (FIG. 1). The segmentation model 800 may be any of a variety of models that perform the segmentation process. In the present embodiment, a trained model called “Multi-class selfie segmentation mode” included in a library called “MediaPipe” provided by Google is used as the segmentation model 800. This model takes in an image of a person, identifies the background, hair, body (skin), face (skin), clothes, and other (accessories) regions, and outputs an image segmentation map that represents each of the identified regions. The processor 210 generates segmentation map data by executing the operations of the segmentation model 800 using the input image IM10. It should be noted that the processor 210 may have the GPU 260 execute some or all of the operations of the segmentation model 800. The image pM32 on the right-hand side of the first row of FIG. 7 shows an example of a segmentation map. The segmentation map pM32 shows a face skin region P1, body skin region P2, hair region P3, clothing region P4, and background BG, each indicated in a different color.

In S234 (FIG. 6), the processor 210 performs a region contour extraction process for the segmentation map generated in S232. The region contour extraction process may be any process that extracts the contours of each of the multiple regions represented by the segmentation map. In the present embodiment, the processor 210 extracts the contours using boundary tracking. The algorithm for this process is disclosed in the following paper, for example.

Satoshi Suzuki and Keiichi Abe, “Topological Structural Analysis of Digitized Binary Images by Border Following”, Computer Vision, Graphics, and Image Processing, Volume 30, Issue 1, April 1985, Pages 32-46

The contents of the above paper is incorporated herein by reference.

An image pM34 on the right-hand side of the second row of FIG. 7 shows an example of an image generated in S234 (hereinafter, called as a contour segmentation map pM34). As shown in FIG. 7, the contour segmentation map pM34 represents an image in which the contours C1, C2, C3, and C4 of the regions P1, P2, P3, and P4 have been added to the segmentation map pM32. In the present embodiment, the processor 210 generates a contour segmentation map pM34 that represents the extracted contours C1, C2, C3, and C4 by lines. The contours C1, C2, C3, and C4 are represented in a particular color (black in the present embodiment) that differs from any of the colors of the regions P1, P2, P3, P4, and BG.

In S236 (FIG. 6), the processor 210 generates grayscale image data by performing a grayscale process on the contour segmentation map generated in S234. The grayscale process is performed in the same manner as in S222. In the present embodiment, the process in S236 generates a grayscale image in which each region is represented with a brightness value brighter than the contour. An image pM36 on the right-hand side of the third row in FIG. 7 shows an example of a grayscale image generated in S236. The grayscale image PM36 shows the contours C1, C2, C3, and C4, which are represented in black, and the regions P1, P2, P3, P4, and BG, which are represented in a lighter color.

In S238 (FIG. 6), the processor 210 performs an adjustment process for the pixel values (here, luminance values) of the grayscale image generated in S236. The adjustment process may be any process that generates an image in which the contours are represented in black and the regions outside the contours are represented in white. In the present embodiment, the processor 210 sets the pixel values that are equal to or greater than a contour threshold to white (in this case, 255). As a result, the colors of the pixels in regions other than the contour are set to white. The color of the contour has already been set to black in S234. The contour threshold is determined experimentally in advance to be a value that is greater than zero (black) and smaller than the luminance values for each region obtained in S232-S236.

An image pM38 on the right-hand side of the fourth row of FIG. 7 shows an example of a grayscale image generated in S238. The grayscale image pM38 shows the contours C1, C2, C3, and C4 of the regions P1, P2, P3, and P4, respectively. The grayscale image PM38 is an example of a contour image that represents the contour of the object represented by the target image (hereafter, the grayscale image PM38 is also referred to as the contour image PM38).

The contour image obtaining process PB (FIG. 6) is terminated as described above. In S240, the processor 210 generates a composite image by combining the detail image PM28 and the contour image PM38. Processor 210 generates a composite image that represents multiple images that are superimposed. The composite image generated in S240 represents an image that represents a superimposition of the detail image PM28 and the contour image PM38. In S245, the processor 210 sets the pixel values of the pixels in the composite image that indicate a luminance of less than the composite threshold to black.

An image IM20 in FIG. 7 shows an example of a composite image generated in S240-S245. The composite image IM20 represents both the contours C1, C2, C3, and C4 represented by the contour image PM38 and the fine features (e.g., eyes Pe, nose Pn, mouth Pm) of the object OB represented by the detail image PM28.

The method for calculating the pixel values (in this case, luminance values) of the pixels in the composite image in S240 may be any of a variety of methods. In the present embodiment, the processor 210 calculates the pixel values of the composite image by performing an alpha blend between the pixel values of the detail image pM28 and the pixel values of the contour image pM38. Alpha values (i.e., the respective weights of the detail image pM28 and the contour image pM38) may be various values. For example, the alpha values may be determined so that the weights are equal between the detail image pM28 and the contour image pM38. Alternatively, the alpha values may be determined so that the weights are unequal between the detail image pM28 and the contour image pM38. The alpha value may be determined experimentally in advance so that the composite image can represent both the contours and fine features. After calculating the luminance values of respective pixels of the composite image, the processor 210 converts the luminance values of respective pixels into pixel values (here, gradation values of R, G, and B components) that are suitable for the generative model 900 (FIG. 2). This conversion of pixel values may be the inverse of the conversion of S222 and S236. It is noted that the pixel values may be converted assuming that the color of each pixel is achromatic.

In the composite image generated in S240, the color of pixels representing edges or contours can be set to a lighter color than black through the alpha blending operation. In S245, the processor 210 sets such bright colors to black. The composite threshold is pre-set to a value greater than the luminance value that can be taken by the pixels representing the edges or contours in the image generated in S240.

After S245, the processor 210 terminates the process shown in FIG. 6, that is, S120 in FIG. 4. In S130, the processor 210 obtains new image data by inputting the composite image data generated in S120 into the generative model 900 (FIG. 2). In the present embodiment, the processor 210 uses the first adjustment parameter 990a (FIG. 2). In this way, the generative model 900 generates an output image that expresses the same content as the composite image in a line drawing style.

It should be noted that the processor 210 inputs the text (e.g., text indicating a style such as “line drawing style”) that is suitable for the adjustment parameter used as the text Ptx (here, the first adjustment parameter 990a) into the generative model 900. The text Ptx may be set by the user. Alternatively, the processor 210 may use a text that is pre-mapped to the adjustment parameter to be used as the text Ptx. The input of the text Ptx may be omitted. Further, the processor 210 may have the GPU 260 execute some or all of the operations of the generative model 900.

An image IM30 in FIG. 5 shows an example of an output image generated in S130. As described above, the output image IM30 is generated using the composite image IM20, which is a composite of the detail image PM28 and the contour image PM38. The output image IM30 represents the same object OBA as the object OB in the composite image IM20.

The composite image IM20 represents the contours C1, C2, C3, and C4 of the object OB. Therefore, the generative model 900 can generate an output image IM30 that represents the contours C1a, C2a, C3a, and C4a, which correspond to the contours C1, C2, C3, and C4 of the composite image IM20, respectively.

The composite image IM20 represents the eyes Pe, the nose Pn, and the mouth Pm, which are examples of the fine features of the object OB. Therefore, the generative model 900 can generate an output image IM30 that represents the eyes Pea, the nose Pna, and the mouth Pma, which correspond to the eyes Pe, the nose Pna, and the mouth Pma of the composite image IM20, respectively.

In the composite image IM20, the pixel values of the pixels that represent portions different from the contours C1, C2, C3, C4 and the fine features of the object OB are set to white. In other words, each of the regions P1, P2, P3, P4 and BG is not colored. Therefore, the generative model 900 can generate an output image IM30 that represents the uncolored regions P1a, P2a, P3a, P4a, and BGa, which correspond to the regions P1, P2, P3, P4, and BG of the composite image IM20, respectively.

Unlike an exemplary output image IM10o shown in FIG. 3, such an output image IM30 is represented in a line drawing style corresponding to the first adjustment parameter 990a.

After S130 (FIG. 4), in S140, the processor 210 stores the output image data in the storage device 215 (e.g., non-volatile storage device 230). The processor 210 then terminates the processes shown in FIG. 4. The output image data can be used for various processes (e.g., for printing, displaying, and the like).

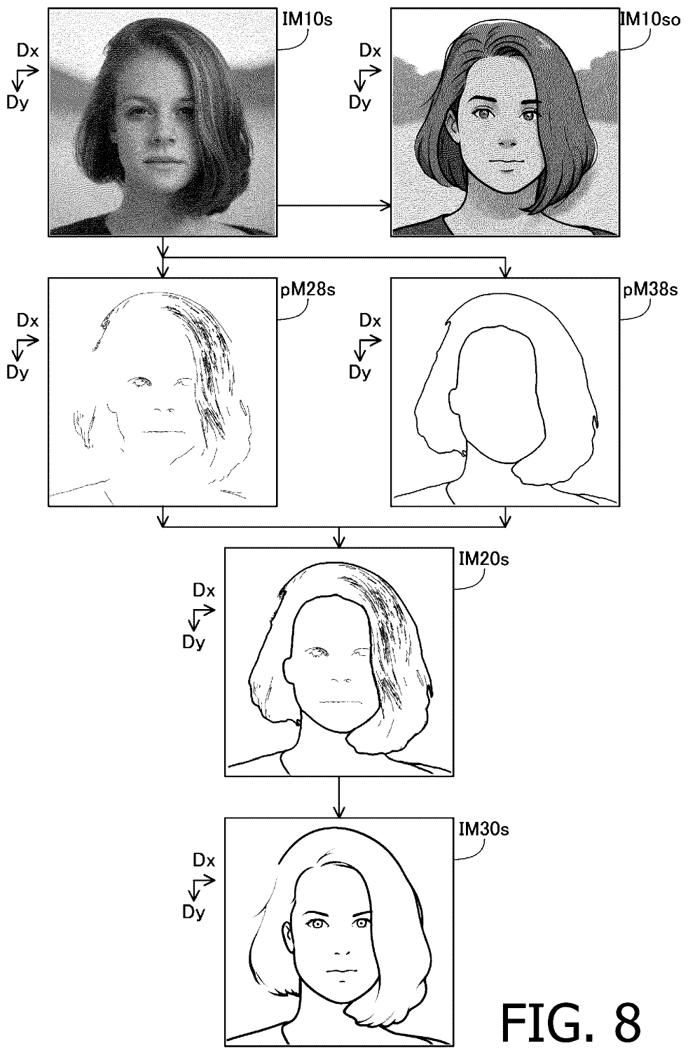

FIG. 8 shows an example of an image obtained by image processing using a sample image. An image IM10s on the left-hand side of the first row in FIG. 8 is an example of a target image. The target image IM10s represents a photograph of a person. Although the target image IM10s is a color image, in FIG. 8, the target image IM10s is expressed by multiple black dots obtained by halftoning.

An image IM10so, which is located on the right-hand side of the target image IM10s, is an output image obtained by inputting the target image IM10s into the generative model 900 (FIG. 2). Although the output image IM10so is a grayscale image, in FIG. 2, the output image IM10so is expressed by multiple black dots obtained by halftoning in FIG. 2. The output image IM10so shows the contours of regions for the hair, body skin, face skin, and clothes, respectively, with lines. However, in the output image IM10so, these regions and the background are expressed by using grayscale tones as a substitute for color information to depict a gradation of colors. This style of the output image IM10so differs from the intended line drawing style.

The image pM28s on the left-hand side of the second row in FIG. 8 is a detail image obtained by applying the detail image obtaining process PA (FIG. 6) to the target image IM10s. The detail image pM28s shows the detailed features of a person, including the eyes, nose, and mouth. However, the detail image pM28s does not show the contours of the hair region, body skin region, face skin region, or clothing region.

An image pM38s on the right-hand side of the second row in FIG. 8 is a contour image obtained by applying the contour image obtaining process PB (FIG. 6) to the target image IM10s. The image pM38s shows the contours of the hair region, body skin region, face skin region, and clothing region, each with a line. However, the image pM38s does not show the fine features of the eyes, nose, mouth, or the like.

An image IM20s in the third row of the FIG. 8 is a composite image obtained by combining the detail image PM28s and the image PM38s (FIG. 6: S240-S245). The composite image IM20s represents the detailed features of a person, including the eyes, nose and mouth, and also shows the contours of the hair region, body skin region, facial skin region and clothing region with lines.

An image IM30s in the fourth row of FIG. 8 is an output image that is generated by inputting the composite image IM20s into the generative model 900 (FIG. 2). The output image IM30s shows the detailed features of a person, including the eyes, nose and mouth, with lines. Further, the output image IM30s shows the contours of the hair region, bodily skin region, facial skin region, and clothing region, respectively, with lines. In this way, the generative model 900 can generate the output image IM30s, which expresses the same content as the target image IM10s in the style of a line drawing, by using the composite image IM20s.

As described above, in the present embodiment, the processor 210 performs the following processes according to the program 231. In S110 (FIG. 4), the processor 210 obtains the target image IM10 representing the object OB (FIG. 5). In S120, the processor 210 obtains the contour image PM38 and the detail image PM28, and generates the composite image IM20 by combining the contour image PM38 and the detail image PM28. The composite image IM20 represents an image created by superimposing the contour image PM38 and the detail image PM28. In the present embodiment, in S120, the processor 210 performs the processes shown in FIG. 6.

The process in FIG. 6 includes the detail image obtaining process PA and the contour image obtaining process PB. In the contour image obtaining process PB, the processor 210 obtains the contour image PM38 representing the contours C1, C2, C3, and C4 of the object OB. In the detail image obtaining process PA, the processor 210 obtains a detail image pM28 that represents the features (e.g., eyes Pe, nose Pn, mouth Pm) of the object OB. The contour image PM38 does not show these features. As you can see, the detail image PM28 shows the finer features of the object OB than the contour image PM38 does. In S240-S245 (FIG. 6), the processor 210 generates a composite image IM20 by combining the contour image PM38 and the detail image PM28. In S130 (FIG. 4), the processor 210 obtains an output image IM30, which is an example of a new image, by inputting information including the composite image IM20 to the trained generative model 900 (in the present embodiment, the information input to the generative model 900 includes the text Ptx). In this way, the processor 210 can reduce the possibility of images being obtained that do not show the contours and features of objects.

In the present embodiment, the detail image obtaining process PA (FIG. 6) includes a process (S210, S222-S228) of generating an edge image PM28 (FIG. 5) representing edges of an object OB as a detail image. The edges of the object OB can represent the detailed features of the object OB, such as the eyes Pe, nose Pn, and mouth Pm. By generating the composite image IM20 using the detail image PM28 that represents such edges, the processor 210 can reduce the possibility of obtaining an image that does not represent the features of the object.

In the present embodiment, the contour image obtaining process PB (FIG. 6) includes processes (S210, S232-S238) of generating an image pM38 representing the contours C1, C2, C3, C4 (FIG. 5) of an object OB as a contour image. By generating the composite image IM20 using the contour image PM38, which represents the contours as lines, the processor 210 can reduce the possibility of obtaining an image that does not represent the contours of the object. In the present embodiment, the object OB (FIG. 5) includes a face that contains N parts (N is an integer greater than or equal to 1) selected from the eyes, nose, and mouth. In the example shown in FIG. 5, the face of the object OB in the target image IM10 contains two eyes, one nose, and one mouth, therefore N=4. In the detail image obtaining process PA (FIG. 6), the processor 210 generates the image pM28 (FIG. 5) as the detail image, which represents one or more of the N parts. In the contour image obtaining process PB, the processor 210 generates the image PM38 as a contour image. The image pM38 represents the contour C1 of the facial skin region P1 (i.e., the contour of the face) without representing N parts. Therefore, the processor 210 can obtain an output image that represents one or more parts selected from the eyes, nose, and mouth, as well as the contour of the face, as in the output image IM30 of FIG. 5.

In the present embodiment, a combination of the diffusion model 960 and the first adjustment parameter 990a is used as the generative model 900 (FIG. 2). This type of generative model 900 is an example of a model that generates a line drawing that represents the input image with lines. By using this type of generative model 900, the processor 210 can transfer the style of the input image to a line drawing.

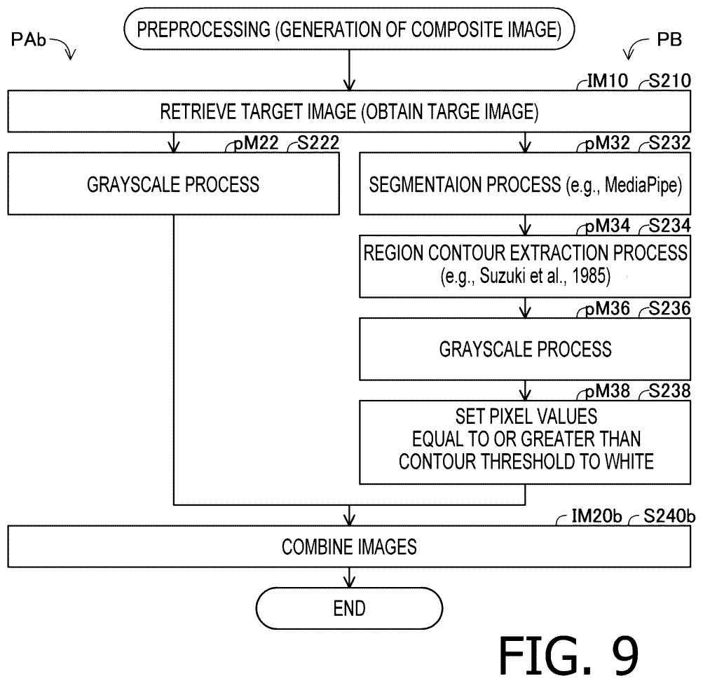

FIG. 9 is a flowchart showing another embodiment of preprocessing. The process in FIG. 9 may be performed at S120 (FIG. 4) instead of the above preprocessing (FIG. 6). There are two main differences between this embodiment and the embodiment shown in FIG. 6.

The first difference is that S224, S226, and S228 have been omitted from the detail image obtaining process PAb. The grayscale image pM22 generated in S222 is used as the detail image as it is. The second difference is that S245 has been omitted. The processing of the other parts of the preprocessing is the same as the corresponding parts of FIG. 6. For example, the contour image obtaining process PB in FIG. 9 is the same as the contour image obtaining process PB in FIG. 6.

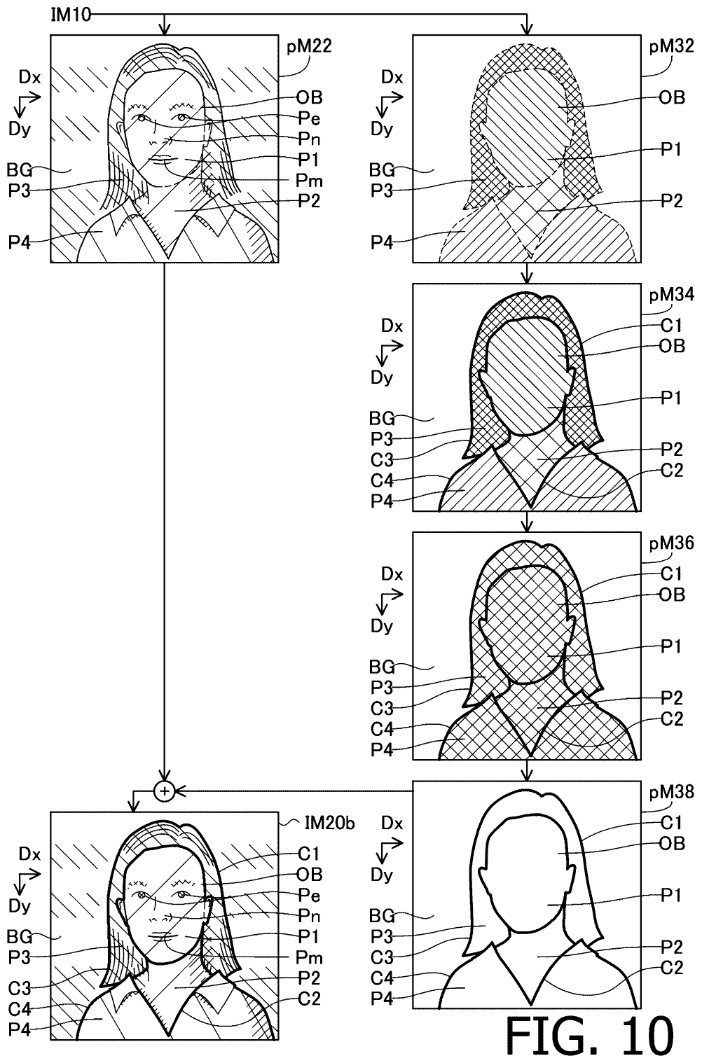

FIG. 10 shows examples of images processed by preprocessing. It is assumed that, as in the example in FIG. 7, the target image IM10 is used. The grayscale image pM22 generated in S222 (FIG. 9) is the same as the grayscale image pM22 in FIG. 7. The images pM32, pM34, pM36, and pM38 generated by the contour image obtaining process PB are the same as the images pM32, pM34, pM36, and pM38 in FIG. 7, respectively.

In S240b (FIG. 9), the processor 210 generates a composite image by combining the detail image pM22 and the contour image pM38. A composite method is the same as the composite method in S240 of FIG. 6. The image IM20b in FIG. 10 shows examples of composite images. The composite image IM20b is the same as the image obtained by superimposing contours of the contour image PM38 on the grayscale image PM22. The composite image IM20b represents both the contours C1, C2, C3, and C4, which are represented by the contour image PM38, and the fine features of the object OB (e.g., eyes Pe, nose Pn, mouth Pm), which are represented by the grayscale image PM22.

After S240b (FIG. 9), the processor 210 terminates the processing of FIG. 9, that is, S120 of FIG. 4. The processing of S130 is the same as the processing of S130 in the example of FIG. 5, except that the composite image IM20b (FIG. 10) is used instead of the composite image IM20 (FIG. 5).

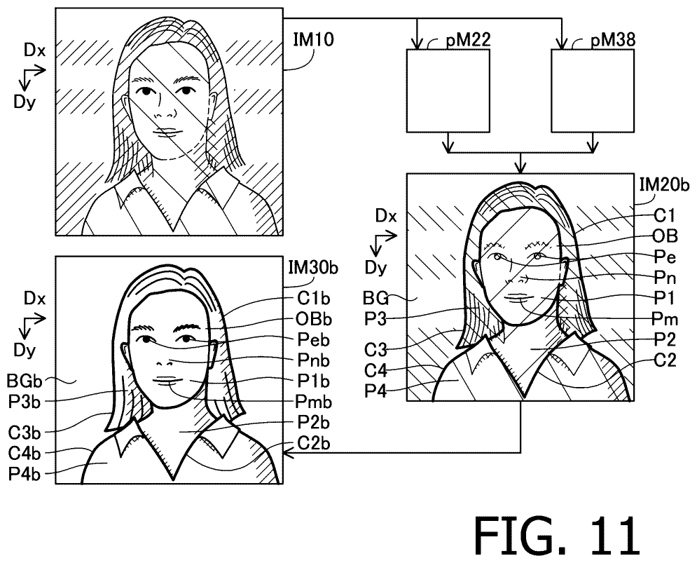

FIG. 11 shows examples of images processed by image processing. The image IM30b represents an example of an output image generated in S130 (FIG. 4). The output image IM30b represents an object OBb that is the same as the object OB in the composite image IM20b. The output image IM30b shows the contours C1b, C2b, C3b, and C4b corresponding to the contours C1, C2, C3, and C4 of the composite image IM20b, respectively, with lines. The output image IM30b represents the eyes PeB, nose PnB, and mouth Pmb, which correspond to the eyes Pe, nose Pn, and mouth Pm of the composite image IM20b, respectively.

In the present embodiment, the output image IM30b represents the regions P1b, P2b, P3b, P4b, and BGb, which correspond to the regions P1, P2, P3, P4, and BG of the composite image IM20b, respectively. The composite image IM20b, like the grayscale image PM22 (FIG. 10), represents the gradation of colors in each region P1, P2, P3, P4, and BG by using grayscale tones as a substitute for color information. Therefore, the regions P1b, P2b, P3b, P4b, and BGb of the output image IM30b are different from the regions P1a, P2a, P3a, P4a, and BGa of the output image IM30 in FIG. 5, and can express a color gradation using the grayscale tones.

It should be noted that the composite image IM20b regions P1, P2, P3, P4, and BG are different from the target image IM10 regions P1, P2, P3, P4, and BG, and are not colored with any colors. Therefore, unlike the output image IM10o in the reference example in FIG. 3, the processor 210 can generate an output image IM30b that represents the regions P1b, P2b, P3b, P4b, and BGb, which are not colored darkly but are light in color. The style of the output image IM30b is closer to the intended line drawing style than the style of the output image IM10o in FIG. 3, which is a reference example.

As described above, in the present embodiment, the detail image obtaining process PAb (FIG. 9) includes a process (S210, S222) for generating a grayscale image PM22 (FIG. 10) representing the target image IM10 in grayscale as a detail image. The grayscale image pM22 can express the fine features of the object OB, such as the eyes Pe, nose Pn, and mouth Pm. By using such a detail image pM22 to generate a composite image IM20b, the processor 210 can reduce the possibility of obtaining an image that does not express the features of the object.

According to the present embodiment, in the detail image obtaining process PAb, the processor 210 generates an image PM22 (FIG. 10) representing one or more of N parts selected from the eyes, nose, and mouth as the detail image, in the same way as the detail image obtaining process PA in FIG. 6. Therefore, in the present embodiment where the detail image obtaining process PAb and the contour image obtaining process PB are performed, the processor 210 performs the detail image obtaining process PAb and the contour image obtaining process PB, the processor 210 can obtain an output image that represents one or more parts selected from the eyes, nose, and mouth, as well as the contour of the face, as in the output image IM30b of FIG. 11.

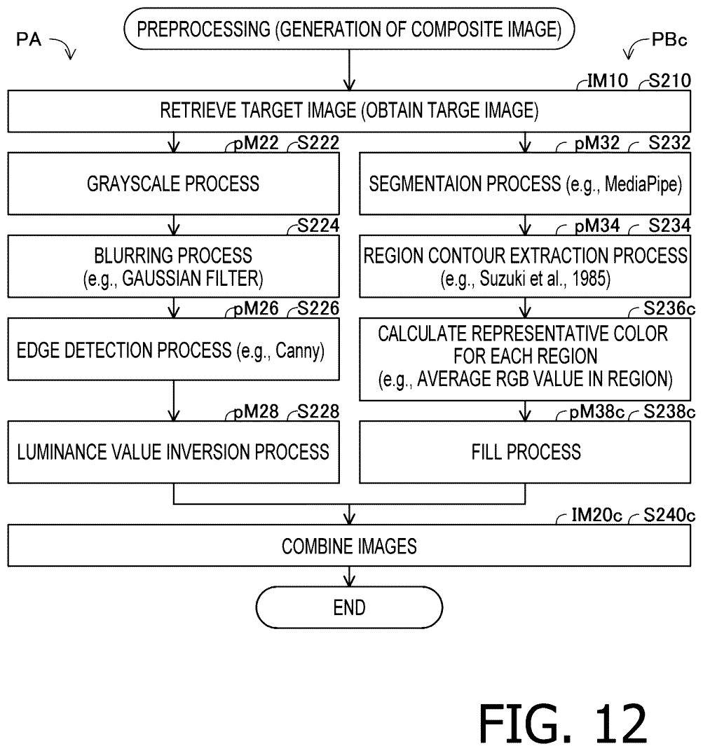

FIG. 12 is a flowchart that represents another embodiment of preprocessing. The process shown in FIG. 12 may be performed in S120 (FIG. 4) instead of the preprocessing (FIG. 6 or 9) described above. There are two main differences between this embodiment and the embodiment shown in FIG. 6. The first difference is that S236 and S238 are replaced with S236c and S238c, respectively. The contour image obtaining process PBc includes S210, S232, S234, S236c, and S238c. The second difference is that S245 is omitted. The processing of the other parts of the preprocessing is the same as the corresponding parts of FIG. 6. For example, the detail image obtaining process PA is the same as the detail image obtaining process PA in FIG. 6.

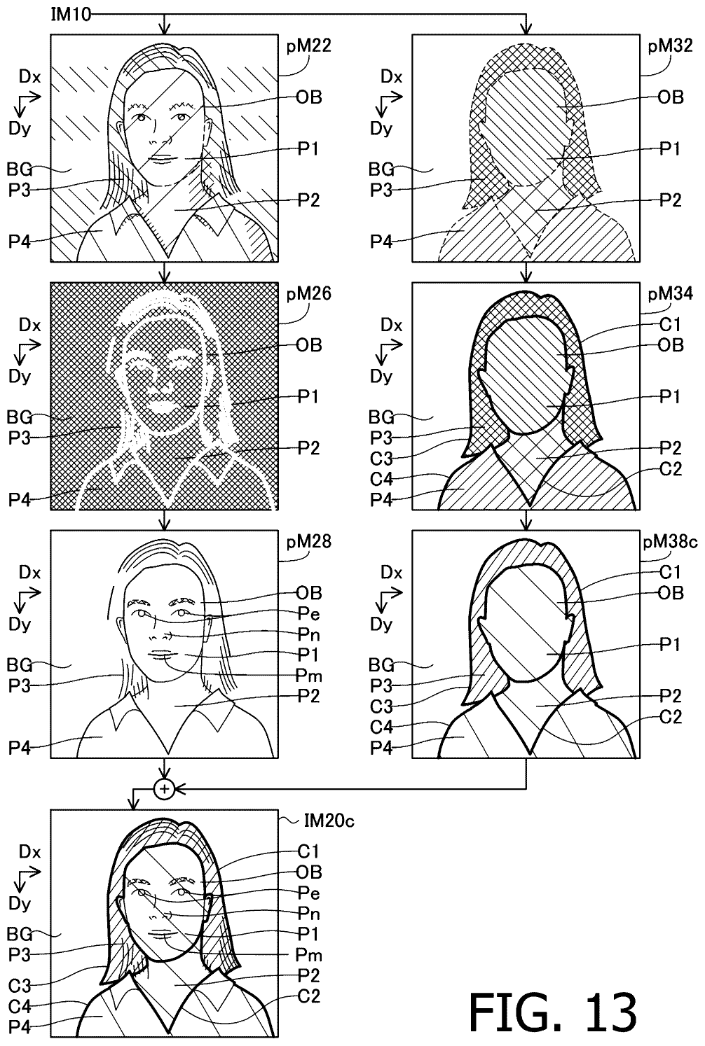

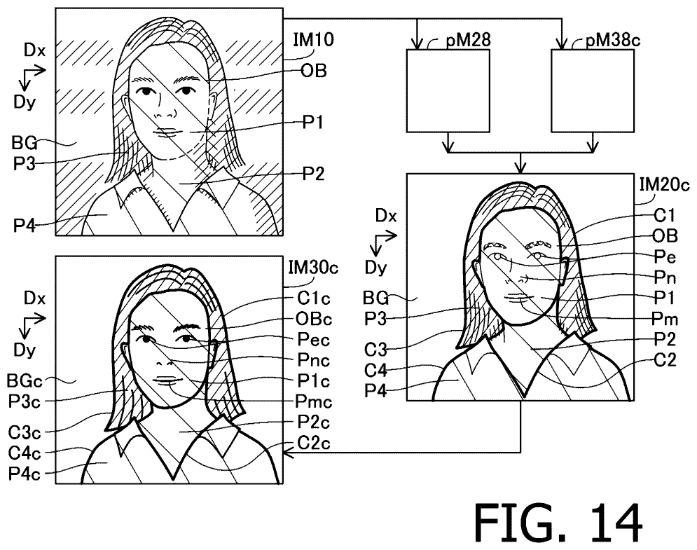

FIG. 13 shows examples of images that are processed by preprocessing. FIG. 14 shows examples of images that are processed by image processing. As in the example in FIG. 7, the target image IM10 (FIG. 14) is used in the above examples. The images pM22, pM26, and pM28 (FIG. 13) generated by the detail image obtaining process PA (FIG. 12) are the same as the images pM22, pM26, and pM28 in FIG. 7, respectively. The images pM32 and pM34 generated in S232 and S234 of the contour image obtaining process PBc are the same as the images pM32 and pM34 in FIG. 7, respectively.

In S236c (FIG. 12), the processor 210 calculates the representative color of each region obtained in S232. The representative color of the region of interest may be a variety of colors that represent the colors of multiple pixels contained in the region of interest in the target image IM10 (FIG. 14). In the present embodiment, the processor 210 calculates the color represented by the average value of each of the RGB values as the representative color. Instead of the average value, various values that represent an amplitude of the grayscale value, such as the most frequent value or the median, may be used.

In S238c (FIG. 12), the processor 210 fills in the interior of the contours of each region of the contour segmentation map pM34 generated in S234 with the representative color calculated in S236c. An image pM38c in FIG. 13 shows an example of the filled image generated in S238c. In the filled image pM38c, the facial skin region P1 is filled with the representative color of the facial skin region P1 of the target image IM10 (FIG. 14). The other regions P2, P3, P4, and BG in the filled image pM38c are also filled in with the representative colors of the corresponding regions P2, P3, P4, and BG in the target image IM10. The contours extracted in S234 are maintained. In this way, the filled image pM38c represents the contours C1, C2, C3, and C4 of respective regions P1, P2, P3, and P4. The filled image pM38c is used as a contour image (the filled image pM38c will also be referred to as the contour image pM38c).

In S240c (FIG. 12), the processor 210 generates a composite image by combining the detail image pM28s and the contour image pM38c. The method of combining is the same as the method of combining in S240 of FIG. 6. An image IM20c in FIG. 13 represents an example of the composite image. The composite image IM20c is the same as the image obtained by superimposing the edges represented by the detail image PM28 on the filled image PM38c. The composite image IM20c represents both the contours C1, C2, C3, C4 represented by the contour image PM38c and the fine features of the object OB represented by the detail image PM28s (e.g., eyes Pe, nose Pn, mouth Pm). Further, in the composite image IM20c, the regions P1, P2, P3, P4, and BG are filled with colors that represent the corresponding regions of the target image IM10.

After S240c (FIG. 12), the processor 210 terminates the processing of FIG. 12, i.e., S120 of FIG. 4. The processing in S130 of FIG. 12 is similar to the processing in S130 of FIG. 5 except that the processing in S130 uses a composite image IM20c (FIG. 13) instead of the composite image IM20 (FIG. 5), and a second adjustment parameter 990b is used instead of the first adjustment parameter 990a.

An image IM30c in FIG. 14 represents an example of an output image generated in S130. The output image IM30c represents the same object OBc as the object OB in the composite image IM20c. The output image IM30c represents the contours C1c, C2c, C3c, and C4c, which correspond to the contours C1, C2, C3, and C4 of the composite image IM20c, respectively, with lines. The output image IM30c represents the eyes Pec, nose Pnc, and mouth Pmc, which correspond to the eyes Pe, nose Pn, and mouth Pm of the composite image IM20c, respectively.

In the present embodiment, the output image IM30c represents the regions P1c, P2c, P3c, P4c, and BGc, which correspond to the regions P1, P2, P3, P4, and BG of the composite image IM20c, respectively. In the composite image IM20c, the regions P1, P2, P3, P4, and BG are filled with the representative colors of the corresponding regions P1, P2, P3, P4, and BG of the target image IM10, respectively. In S130 (FIG. 4), the processor 210 uses the second adjustment parameter 990b for anime art. Therefore, the processor 210 can generate an output image IM30c that represents the regions P1c, P2c, P3c, P4c, and BGc, which are filled with the same colors as the regions P1, P2, P3, P4, and BG of the composite image IM20c, respectively. The output image IM30c represents the target image IM10 with lines and a color palette with fewer colors than the number of colors in the target image IM10. Such an output image IM30c is represented in an intended anime art style.

As described above, in the present embodiment, a combination of the diffusion model 960 and the second adjustment parameter 990b are used as the generative model 900 (FIG. 2). Such a generative model 900 is an example of a model that generates an image representing an input image with lines and a number of colors less than the number of colors of the input image. By using such a generative model 900, the processor 210 can transfer the style of the input image to another style (e.g., anime art) that is represented by lines and a smaller number of colors than the number of colors in the input image.

In the present embodiment, as shown in FIG. 14, the target image IM10 represents an object OB and a background BG. The background BG is an example of an outer part that is in contact with the object OB. The object OB contains multiple regions P1, P2, P3, and P4, corresponding to multiple parts that differ from each other. The contour image obtaining process PBc (FIG. 12) includes S236c and S238c. In S236c and S238c, the processor 210 fills regions P1, P2, P3, P4, and BG with their respective representative colors. In other words, an image pM38c (FIG. 13) generated by the contour image obtaining process PBc represents the object OB and the background BG in different colors. Further, an image pM38c shows the multiple regions P1, P2, P3, and P4 of the object OB as monochromatic regions that represent the representative colors of the corresponding regions.

In the contour image obtaining process PBc, the processor 210 generates such an image PM38c as a contour image. Processor 210 generates a composite image IM20c using such a contour image PM38c, and generates an output image IM30c by inputting the composite image IM20c into the generative model 900. Therefore, the processor 210 can generate an output image IM30c that expresses the same content as the content of the target image IM10 using lines and a smaller number of colors than the number of colors in the target image IM10.

In the present embodiment, the contour image obtaining process PBc (FIG. 12) includes processes (S210, S232, S234, S236c, S238c) for generating the contour image PM38c, which represents the contours C1, C2, C3, and C4 (FIG. 13) of the object OB with lines. The processor 210 can reduce the possibility of obtaining an image that does not represent the contours of the object OB by generating the composite image IM20c using the contour image pM38c that represents the counter with lines as described above.

According to the present embodiment, in the contour image obtaining process PBc, the processor 210 generates the image PM38c (FIG. 13) as a contour image in the same way as is done in the contour image obtaining process PB of FIG. 6. Unlike the detail image PM28, the image PM38c represents the contour C1 of the facial skin region P1 (i.e., the contour of the face) without representing the N parts selected from the eyes, nose, and mouth. Therefore, in the present embodiment where the detail image obtaining process PA and the contour image obtaining process PBc are executed, the processor 210 obtains the detail image PA and the contour image PBc, the processor 210 can obtain an output image that represents one or more parts selected from the eyes, nose, and mouth, as well as the contour of the face, as shown in the output image IM30c in FIG. 14.

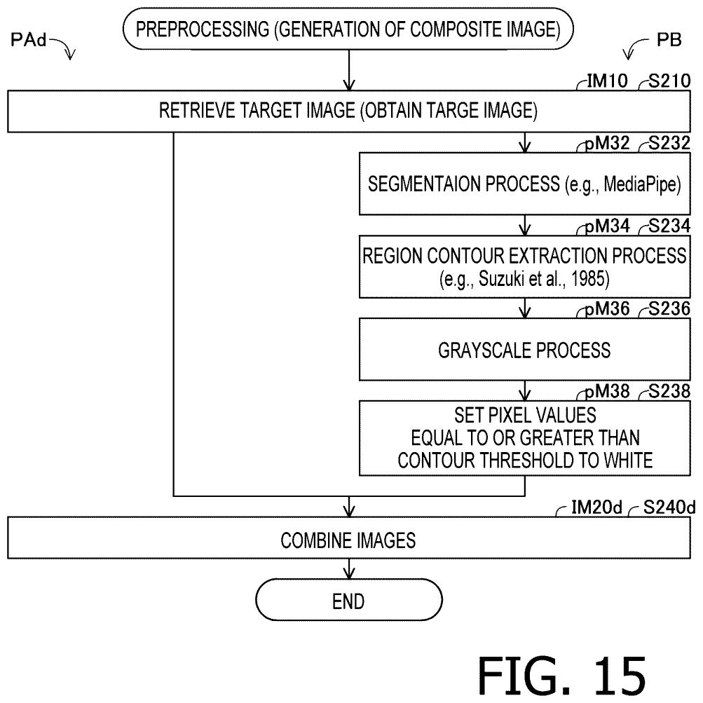

FIG. 15 is a flowchart that represents another embodiment of the preprocessing. The process shown in FIG. 15 may be performed at S120 (FIG. 4) in place of the preprocessing (FIGS. 6, 9, and 12) described above.

There are essentially two differences between the embodiment in FIG. 6 and the present embodiment. The first difference is that S222 to S228, which are included in the detail image obtaining process PA shown in FIG. 6, have been omitted, while S210 remains in the detail image obtaining process PA shown in FIG. 15. The target image obtained in S210 is used as the detail image as it is in the preprocessing shown in FIG. 15.

The second difference is that S245 is omitted in FIG. 15. The other parts of the preprocessing are the same as the corresponding parts in FIG. 6. For example, the contour image obtaining process PB in FIG. 15 is the same as the contour image obtaining process PB in FIG. 6.

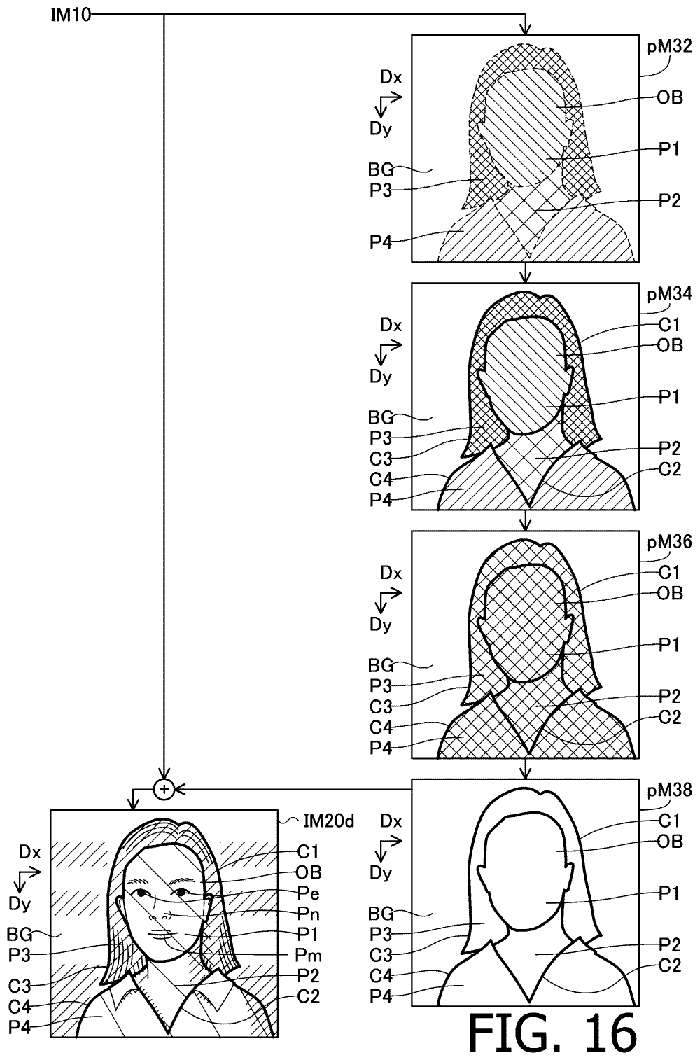

FIG. 16 shows examples of images processed by preprocessing. FIG. 17 shows examples of images processed by image processing. As in the example shown in FIG. 7, the target image IM10 (see FIG. 17) is used in the above examples. The images pM32, pM34, pM36, and pM38 (FIG. 16) generated by the contour image obtaining process PB are the same as the images pM32, pM34, pM36, and pM38 in FIG. 7, respectively.

In S240d (FIG. 15), the processor 210 generates a composite image by combining the target image IM10, which is a detail image, and the contour image PM38. The composition method is the same as that used in S240 of FIG. 6. The image IM20d in FIG. 16 shows an example of a composite image. The composite image IM20d is the same as the image obtained by superimposing the contours of the contour image PM38 on the target image IM10 (FIG. 17). The composite image IM20d represents both the contours C1, C2, C3, and C4 represented by the contour image PM38 and the fine features (e.g., eyes Pe, nose Pn, mouth Pm) of the object OB represented by the target image IM10.

After S240d (FIG. 15), the processor 210 terminates the processing of FIG. 15, that is, S120 of FIG. 4. The processing of S130 is the same as the processing of S130 in the embodiment shown in FIG. 5, except that the composite image IM20d (FIG. 16) is used instead of the composite image IM20 (FIG. 5). For example, in the present embodiment, a first adjustment parameter 990a is used.

An image IM30d in FIG. 17 shows an example of an output image generated by S130 (FIG. 4). The output image IM30d represents an object OBd that is the same as the object OB in the composite image IM20d. The output image IM30d represents the contours C1d, C2d, C3d, and C4d, which correspond to the contours C1, C2, C3, and C4 of the composite image IM20d, respectively, with lines. The output image IM30d represents the eyes PeD, nose PnD, and mouth Pmd, which correspond to the eyes Pe, nose Pn, and mouth Pm of the composite image IM20d, respectively.

In the present embodiment, the output image IM30d represents the regions P1d, P2d, P3d, P4d, and BGd, which correspond to the regions P1, P2, P3, P4, and BG of the composite image IM20d, respectively. The composite image IM20d, like the target image IM10, shows a gradation of colors within each of the regions P1, P2, P3, P4, and BG. Therefore, the regions P1d, P2d, P3d, P4d, and BGd of the output image IM30d can represent a gradation of colors using grayscale, in the same way as in the regions P1z, P2z, P3z, P4z, and BGz of the output image IM10o in the reference example shown in FIG. 3. It should be noted, however, that the output image IM30d is different from the output image IM10o in FIG. 3 in that the output image IM30d appropriately represents the contours of the respective regions P1d, P2d, P3d, and P4d. The style of the output image IM30d is closer to the intended line drawing style than the style of the output image IM10o in FIG. 3.

As described above, in the present embodiment, the processor 210 obtains the target image IM10 (FIG. 17) as a detail image in S210 (FIG. 15). The target image IM10 can represent the detailed features of the object OB, such as the eyes Pe, nose Pn, and mouth Pm. The processor 210 uses such a target image IM10 as a detail image to generate a composite image IM20d. In this way, the processor 210 can reduce the possibility of an image that does not express the features of the object being obtained.

According to the present embodiment, in the detail image obtaining process PA, the processor 210 generates an image IM10 (FIG. 17) representing one or more of N parts selected from the eyes, nose, and mouth as the detail image, in the same way as the detail image obtaining process PA in FIG. 6. Therefore, in the present embodiment where the detail image obtaining process PA and the contour image obtaining process PB are executed, the processor 210 can obtain an output image that represents one or more parts selected from the eyes, nose, and mouth, as well as the face contour, as the output image IM30d shown in FIG. 17, in the same way as the embodiment shown in FIG. 6 where the detail image obtaining process PA and the contour image obtaining process PB are performed.

The process of obtaining a contour image may be any of a variety of processes, instead of the contour image obtaining processes PB and PBc (FIGS. 6, 9, 12, and 15). For example, in S234, the processor 210 may refer to multiple regions determined by segmentation processing, and extract the portions where multiple pixels belonging to different regions are adjacent as portions representing the contours. Further, a contour image may be an image that represents the contours of an object in various ways, instead of an image that represents the contours of an object with lines. For example, a contour image may represent two regions that contact a contour with different colors. Such a contour image may be generated by a process that is obtained by omitting the region contour extraction process (S234) from the contour image obtaining process PBc in FIG. 12. In S238c, the processor 210 fills in the entire region of each region with the corresponding representative color. Although not shown in the drawings, the contour image generated is similar to the image obtained by omitting the contour lines from the filled-in image (e.g., the filled-in image pM38c in FIG. 13). In such a contour image, the parts where the color changes represent the contours. By processing the parts where the color changes as boundaries in this way, the generative model 900 can generate images in the style of line drawings or anime art.

With regard to the processes to obtain the contour image and detail image, various other processes may be used instead of the processes shown in FIGS. 6 (processes PA and PB), 9 (processes PAb and PB), 12 (processes PA and PBc), and 15 (processes PAd and PB). Any one selected from the detail image obtaining processes PA, PAb, and PAd, and any one selected from the contour image obtaining processes PB and PBC may be combined. For example, the contour image obtaining process PBc may be combined with the detail image obtaining process PAb or the detail image obtaining process PAd.

In addition to the contour image and detail image, the image used to generate the composite image may also include another image (e.g., the target image IM10).

The process of generating a new image using a composite image may be any of various processes instead of the process shown in FIG. 4. For example, the start instruction for image processing may include style information specifying whether to use “line drawing” or “anime art.” The processor 210 may proceed with image processing according to the style information. For example, the “line drawing” may be associated with preprocessing of any of FIG. 6, 9, or 15 and the first adjustment parameter 990a. The “anime art” may be associated with preprocessing of FIG. 12 and the second adjustment parameter 990b. The processor 210 may then perform preprocessing associated with the style information and generate an output image from the composite image using adjustment parameters associated with the style information. It should be noted that one of the first adjustment parameter 990a or the second adjustment parameter 990b may be omitted.

The generative model that generates a new image using a composite image can be any of various machine learning models, not just the generative model 900 shown in FIG. 2. For example, the generative model may be a model that performs a task called neural style transfer (such a model is also called a style transfer model). The neural style transfer uses a machine learning model to transfer the style of an image to another style.

The style after transfer may be selected from the following two types.

(Type-1) A style that represents the input image with lines (e.g., line drawing)

(Type-2) A style that represents the input image with lines and a smaller number of colors than the number of colors in the input image (e.g., anime art)

As a Type-1 style, any of a variety of other styles may be used in place of a line drawing (for example, a Sumi-e style, but not limited to these). The first adjustment parameter 990a may be trained using multiple Type-1 style images.

As a Type-2 style, any of a variety of other styles may be used in place of the anime art. For example, a style known as flat color art may be used. The flat color art style is one in which each of the multiple regions contained in an image is represented by a monochromatic region. Here, the contours of respective regions may be represented with lines. Alternatively, the contour lines may be omitted (also, in this case, the parts of the image where the color changes represent the contours). In either case, the second adjustment parameter 990b may be trained using multiple Type-2 style images. When the contour lines are omitted, an image representing the contours using color changes instead of contour lines may be used as a contour image. Such a contour image may be generated, for example, by omitting the region contour extraction process (S234) from the contour image obtaining process PBc in FIG. 12.

It should be noted that the style after conversion can be any of a variety of styles (for example, watercolor style, oil painting style, but not limited to these), not limited to the two styles described above.

As a style transfer model, for example, one that uses a normalization known as adaptive instance normalization (AdaIN) may be adopted. Further, as an architecture for a style transfer model, for example, the architecture of a technique known as “Fast Patch-based Style Transfer of Arbitrary Style” or the architecture of a technique known as “Avatar-Net: Multi-scale Zero-shot Style Transfer by Feature Decoration” may be adopted.

In either case, the generative model may include one or both of a model that generates a line drawing representing the input image with lines, and a model that generates an image representing the input image with lines and a number of colors less than the number of colors in the input image.

The segmentation model 800 (FIG. 1) may be a model that divides an image into multiple regions, such as Mask R-CNN, YOLO, but not limited to these, instead of the model described above. The segmentation model 800 may be a model that performs region segmentation, referred to as “Instance Segmentation” or “Semantic Segmentation”. Further, the processor 210 may divide the image into multiple regions using other methods, such as template matching, without using a machine learning model.

The objects represented by the target image may be any objects, not limited to people (for example, pets such as dogs and cats, vehicles such as cars and airplanes, and scenery such as the sea and mountains).

The processor 210 may perform various image processing operations, not limited to image processing for transferring the style of an image. For example, the processor 210 may generate a third image by combining a first image and a second image.

In such a case, the processor 210 generates the third image that represents an image obtained by superimposing the first image and the second image. The processor 210 then obtains a new image by inputting the information including the third image to the trained machine learning model. The machine learning model may be any model that generates new images based on input images, not limited to style transfer models. According to such a configuration, the processor 210 can obtain a new image based on features represented by the first image and features represented by the second image.

In the above embodiments and modifications, the processor 210 may cause the GPU 260 to perform various operations. Alternatively, the GPU 260 may be omitted.

The image processing apparatus 200 in FIG. 1 may be a device of a different type from a personal computer (e.g., a digital camera, scanner, or smartphone). Further, multiple devices (e.g., computers) that can communicate with each other via a network may share the image processing functions of the image processing device, with each device handling a portion of the image processing functions (a system comprising these devices corresponds to the image processing device).

In the above embodiments and modifications, some of the hardware-based components may be replaced with software, and conversely, some or all of the software-based components may be replaced with hardware. For example, the processing of the generative model 900 (FIG. 2) shown in FIG. 1 may be performed by a dedicated hardware circuit such as an Application Specific Integrated Circuit (ASIC).

If some or all of the functions of the present disclosure are implemented by a computer program, the program may be provided in the form of a computer-readable storage medium (e.g., a non-transitory storage medium). The program may be used while stored on the same or a different computer-readable storage medium. The “computer-readable storage medium” does not only include portable storage media such as memory cards and CD-ROMs, but may also include internal storage devices such as various ROMs or similar devices in computers, and external storage devices connected to computers such as hard disk drives.

The above-described embodiments and modifications may be combined as appropriate. It should be noted that the above-described embodiments and modifications are provided to facilitate understanding of the present disclosure and are not intended to limit the present disclosure. The present disclosure may be further modified or improved without departing from aspects of the present disclosure, and the present disclosure includes equivalents thereof.

What is claimed is:

1. A non-transitory computer-readable recording medium containing computer-executable instructions that are executable by a controller of an image processing apparatus, wherein the computer-executable instructions is configured to, when executed by the controller, cause the image processing apparatus to:
a first obtaining process of obtaining a target image representing an object;
a second obtaining process of obtaining a contour image and a detail image, the contour image representing a contour of the object, the detail image representing more fine features of the object than features represented by the contour image;
a composing process of generating a composite image by composing multiple images including the contour image and the detail image; and
a third obtaining process of obtaining a new image by inputting the composite image to a machine learning model.

2. The non-transitory computer-readable recording medium according to claim 1,
wherein the second obtaining process includes generating of an edge image representing an edge of the object as the detail image.

3. The non-transitory computer-readable recording medium according to claim 1,
wherein the second obtaining process includes obtaining the target image as the detail image.

4. The non-transitory computer-readable recording medium according to claim 1,
wherein the second obtaining process includes generating a grayscale image representing the target image in grayscale.

5. The non-transitory computer-readable recording medium according to claim 1,
wherein the second obtaining process includes generating an image representing the contour of the object with lines as the contour image.

6. The non-transitory computer-readable recording medium according to claim 1,
wherein the target image expresses the object and an outer part, the outer part is a part contacting with the object,
wherein the object includes multiple regions different from each other, and
wherein the second obtaining process includes generating, as the contour image, an image expressing the object and the outer part with different colors, the multiple regions of the object being represented with representative colors, respectively, each of the representative colors being a monochromatic color representing a color of each of the multiple regions.

7. The non-transitory computer-readable recording medium according to claim 1,
wherein the object includes a face that contains N parts selected from an eyes, a nose, and a mouth, the N being an integer greater than or equal to 1, and
wherein the second obtaining process includes:
generating, as the detail image, an image representing one or more of the N parts; and
generating, as the contour image, an image representing an contour of the face without representing the N parts.

8. The non-transitory computer-readable recording medium according to claim 1,
wherein the machine learning model is one or both of a model configured to generate a line drawing representing an input image with lines and a model configured to generate an image representing an input image with lines and a number of colors less than a number of colors of the input image.

9. A non-transitory computer-readable recording medium containing computer-executable instructions that are executable by a controller of an image processing apparatus, wherein the computer-executable instructions is configured to, when executed by the controller, cause the image processing apparatus to:
generate an image by composing a first image and a second image; and
obtain a new image by inputting the generated image to a machine learning model.

10. An image processing apparatus comprising a controller configured to perform:
obtaining a target image representing an object;
obtaining a contour image and a detail image, the contour image representing a contour of the object, the detail image representing more fine features of the object than features represented by the contour image;
generating a composite image by composing multiple images including the contour image and the detail image; and
obtaining a new image by inputting the composite image to a machine learning model.

11. An image processing apparatus comprising a controller configured to perform:
generating an image by composing a first image and a second image; and
obtaining a new image by inputting the generated image to a machine learning model.
